(19) United States
(12) Patent Application Publication
(10) Pub. No.: US 2014/0125097 A1
(43) Pub. Date: May 8, 2014

(54) Vehicle Armrest Mounted Control Device with Remote Display

(71) Applicant: Dan Marius Andreiu, Hermosa Beach, CA (US)

(72) Inventor: Dan Marius Andreiu, Hermosa Beach, CA (US)

(21) Appl. No.: 14/066,474

(22) Filed: Oct. 29, 2013

Related U.S. Application Data
(60) Provisional application No. 61/719,722, filed on Oct. 29, 2012.
(60) Provisional application No. 61/726,974, filed on Nov. 15, 2012.

(51) Int. Cl. B60N 2/46

(52) U.S. Cl. CPC B60N 2/4693
USPC 297/217.3

(57) ABSTRACT

Vehicle mounted control device and display allow a driver to control vehicle accessories and functions while minimizing distraction. The control device may be mounted at a forward position on the armrest or consul, and is preferably angled forward and downward at about a 45 degree angle. A display is electrically connected to the control device and placed remotely at a convenient viewing position ahead of the driver. The control device may controlled in a tactile manner by mounting it in an open top enclosure having about one inch high walls around the surface of the control device and about a one third inch wide depression margin between the walls and edges of the control device.

The present application claims the priority off U.S. Provisional Patent Application Ser. No. 61/719,722 filed Oct. 29, 2012 and of U.S. Provisional Patent Application Ser. No. 61/726,974 filed Nov. 15, 2012, which applications are incorporated in their entirety herein by reference.

### BACKGROUND OF THE INVENTION

present invention relates to controlling a vehicle's computer, accessories and functions and in particular to an armrest mounted touch pad and the tactile control of the touchpad, touchscreen, touch smart phone or tablet and in particular to such an apparatus mounted in moving vehicle.

Modern vehicles include a variety of accessories, many offering driver control. Also, drivers operate while driving many accessories not included by vehicle's manufacture. Some accessories, such as navigation systems, smart phones, laptop computers, and the like, include touch screens and buttons for controlling functions of the accessory while driving the vehicle. Unfortunately, using such touch screens and buttons often distracts the driver dangerously, being recently a principal source of grave accidents. The principal source of danger comes from moving the driver body while operating the vehicle and so losing the field of view and the orientation of the vehicle, that is done naturally along with the orientation of the driver body. The present invention addresses this problem in principal.

For centuries humans put their thoughts in writing by using comfortable one single dominating hand in order to handwrite with a pen or a pencil. In the year 1808, a less comfortable, but easier to read writing method was invented, the typewriter that, when operated as intended, uses both human hands. Known computer keyboards use the same uncomfortable two hands method of writing, to which was added a mouse or a touchpad. A secondary embodiment of the present invention will address this problem.

### BRIEF SUMMARY OF THE INVENTION

The present invention addresses the above and other needs by providing a centrally located display connected to a control device residing proximal to a relaxed position of a driver's hand. The display may be a touchscreen, or any monitor or computer screen in a vehicle, and the control device may be a touchpad, touch screen, smart phone touchscreen, keypad, or the like. The control device is preferably positioned at an angle under the fingertips in such way that the driver's arm may remain on an armrest or consul and the driver's body does not need to move while using the control device. The driver's arm use remains reserved for the support and orientation of the driver's body in a vehicle, contributing at maintaining the driver's attention to operating the vehicle and at the orientation of the vehicle in a appropriate manner. The control device preferably resides at about a 45 degree angle below an armrest surface. The angle of the fingertips controlling the control device can be changed to personalize the control.

In accordance with one aspect of the invention, there is provided a boxed enclosure about one third of an inch margin from the control device with walls reaching about one inch above the control device. Such boxed enclosure allows the driver's hand to find the boxed enclosure without touching the control device, allows the fingers to slide in and find the margins of the control device without looking and then, with one finger, or more, secured in the depression between the margin of the control device and the enclosure walls, allowing the rest of the fingers to operate the control device without looking at it, while observing the display placed in the central console of the vehicle.

In accordance with another aspect of the invention, there is provided a control device and monitor which can be used by passengers who desire to use a smart phone or the like, placed as described above on an armrest or consul, while the passenger is looking at a display mirroring the smart phone display, but mounted in the vehicle in front of the said passenger. The control device and display is also advantageous for use in an aircraft.

In accordance with yet another aspect of the invention, there is provided a control device and monitor allowing a user to handle a smart phone touchscreen, or any control touch screens or pads or such, placed on an armrest, without looking at said touchscreen(s) but by looking at a mirroring monitor placed in front of the person that does the controlling of the touchscreen placed on the armrest.

In accordance with still another aspect of the invention, there is provided a device which can be attached to any human arm like a wrist watch, with or without a cooperating display in top of the wrist, and with a control device under the fingertips, in order to allow two dimensional remote control of any computer via wires or wireless. The display on top of the wrist can be angled for optimal use and when not in use can be folded down in top of the arm in order not to hamper the normal human arm use. When not in use, the control device can be folded under the human arm enabling to carry the device at all times without hampering the arm's normal human use.

In accordance with another aspect of the invention, there is provided a computer glove controlled by the fingertips.

In accordance with another aspect of the invention, there is provided an optimal angle between the touchscreen/touchpad and the driver's arm which allows touch control by fingertips without utilizing any driver arm muscle that will engage other body muscle as well in the driver body orientation process, allowing driver body orientation independent of the fingers' movement. In order to control a computer, the apparatus essentially uses the optimal and typical hand versus driver arm angle of control commonly used in handwriting. The present invention develops a human habit of typing with one hand, therefore replacing in time the traditional handwriting with a computer assisted more precise method of writing, allowing for a universal computer control with the same device in the same time.

In accordance with another aspect of the invention, there is provided a control device and display which frees human body and it's orientation in space from this constrains. Control of a computer by using two hands and a mouse or a touchscreen generally requires the involvement of two hands and therefore essentially trapping the whole human body in a more or less comfortable position during this operation. The whole human body has to be oriented towards operating the computer. The present invention facilitates use of a single hand thud freeing the user.

A further use of the present invention is the development of a universal one hand typing, total computer touch control, that will be done with the same detachment and comfort as handwriting is done, and may replace one day traditional handwriting.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a side view of an armrest mounted touchpad according to the present invention.

FIG. 1B is a top view of the armrest mounted touchpad according to the present invention.

FIG. 2 shows the touchscreen interfacing with a vehicle accessory such as a vehicle monitor according to the present invention.

FIG. 3A is a top view of the tactile apparatus with a touchscreen smart phone mounted in it according to the present invention.

FIG. 3B is a top and side three-dimensional view of the tactile apparatus with a touchscreen smart phone mounted in it according to the present invention.

FIG. 4A and FIG. 4B the tactile apparatus mounted in two different positions at the end of an armrest.

FIG. 5 shows how the two different positions of the control touchscreen correspond with two different positions of the monitor.

FIG. 6 shows how the control touchscreen smart phone is connected via a HDMI connection and a audio connection to the monitor.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

The operating of a smart device or computer installed in a vehicle, or of a simple navigation system, may create distractions posing great dangers. Unfortunately drivers often take great risks by operating handheld or fix electronic devices like navigation systems, tablets computers, laptops computers and smart phones while operating a vehicle. The principal source of danger comes from moving the driver's body while operating the vehicle in order to operate in the same time a handheld or a fix electronic device, and so losing the field of view and the orientation of the vehicle that is done naturally along with the driver body. The present invention addresses this problem.

Vehicle central display, touchscreen, monitor, or any monitor or computer in a vehicle, is safely controlled by a mirroring of the monitor, mirror touchscreen or touchpad of the monitor positioned at a specific angle under the fingertips in such way that the arm placed on the armrest and the driver body does not need to move while controlling the vehicle's computer via the mirror touchscreen, or touchpad, under the fingertips by touching the touchscreen, or touchpad, with the fingertips. The driver arm use remains reserved for the support and orientation of the driver's body in a vehicle, contributing at maintaining the driver attention at operating the vehicle and at the orientation of the vehicle in a appropriate manner. The touchpad preferably resides at about a 45 degree angle with respect to an armrest surface. That optimum for the fingertips angle of control of the touchscreen or touchpad can be changed to personalize the control.

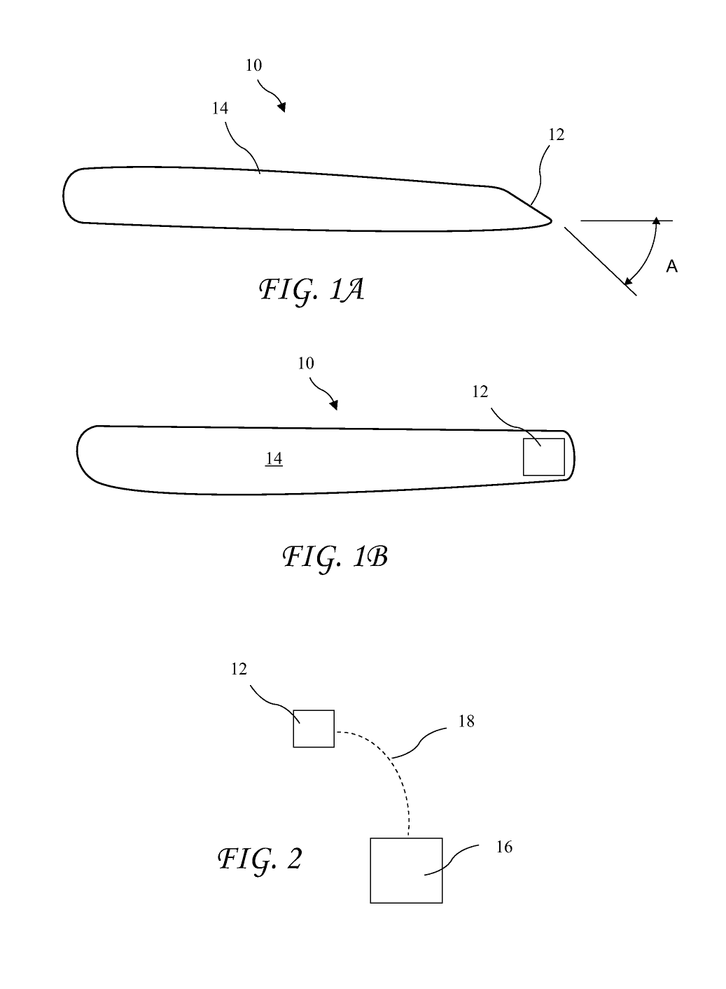

FIG. 1A is a side view of an armrest 10 mounted control device 12 (for example a touchpad or touchscreen) and FIG. 1B is a top view of the armrest 10 mounted control device 12. The armrest 10 includes an armrest surface 14 for resting a driver's arm. The control device 12 is mounted ahead of the armrest surface 14 allowing use while the driver's arm is resting on the armrest surface 14. The control device 12 preferably resides forward and angled downward from the armrest surface 14, and more preferably forward and angled downward from the armrest surface 14 at about a 45 degree angle. The control device 12 is preferably part of the armrest 10.

FIG. 2 shows the control device 12 interfacing with a vehicle accessory such as a display 16. The control device 12 communicates with the display 16 over an interface 18 which may be a wired or wireless interface. Examples of the control device 12 are touchpads, touchscreen. Examples of displays 16 are navigation touchscreen monitors, navigation monitors, computer touchscreen monitors, computer monitors, tablets, smart phones, and the like. The interface may be one way from the control device 12 to the display 16 only, or two way between the control device 12 to the display 16. In other embodiments the control device 12 may be horizontal or angled forward and upward.

The touchpad 12 may alternatively reside on a side surface of the armrest 10 or a back (i.e., towards the front of the vehicle) surface of a vehicle steering wheel.

The present invention thus addresses the above and other needs by providing that a vehicle central display touchscreen, or not touchscreen, monitor, or any monitor or computer in a vehicle, controlled by using the tactile apparatus described by the present invention to handle a mirroring of the monitor, mirror touchscreen or touchpad or touch smart phone of the monitor positioned at a specific angle under the fingertips on the armrest and the driver body does not need to move while controlling the vehicle's computer via the mirror touchscreen, or touchpad, under the fingertips by touching the touchscreen, or touchpad, with the fingertips. The driver arm use remains reserved for the support and orientation of the driver body in a vehicle, contributing at maintaining the driver attention at operating the vehicle and at the orientation of the vehicle in a appropriate manner. The control device 12 may be a touch control smart phone or touchpad or touchscreen preferably residing at about a 45 down degree angle with respect to an armrest surface, in an specifically designed enclosure allowing the driver hand to find the touchscreen smartphone, and such, and to control it without looking at touchscreen while driving a moving vehicle. In one embodiment, fingertips position of control of the touchscreen phone or touchpad is in a boxed enclosure positioned about one third of an inch from the touchscreen and about one inch high from the level of the touchscreen. Such enclosure allows the driver hand to find the boxed enclosure without touching the touchscreen, allows the fingers to slide in and find the margins of the smartphone touchscreen without looking and then, with one finger, or more, secured in the depression between the margin of the touchscreen and the apparatus's wall the rest of the fingers are able to operate the smartphone touchscreen without looking at it, but by looking at the mirror monitor placed in the central console of the moving vehicle.

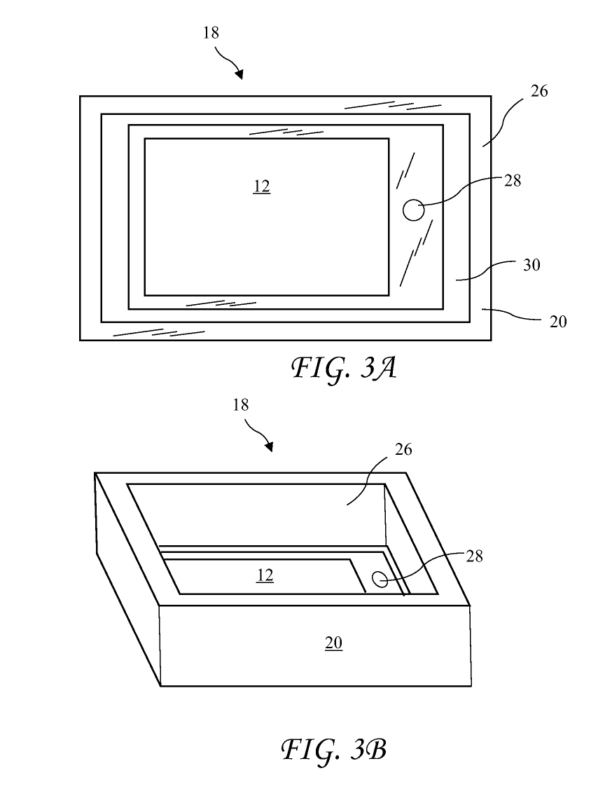

FIG. 3A is a top view of a control device assembly 18 (preferable made out of wood) having a recessed surface 20 at a base of about one inch high wall 16 and FIG. 3B is a perspective view of the control device assembly 18. The control device 12 resides mounted and fixed at the bottom by HDMI, USB and other connections and resides at about one third of an inch inside of about one inch high walls 26 of the apparatus (shown by gap 20). A driver's fingers can find the control device 12 without looking and then fingers can find the control device 12 by sliding fingers of the wall 16 into the depression 14. With one or more fingers secured in the depression 14, the rest of the fingers can operate the touchscreen by sliding on its surface in various pre learn ways or find the menu button 18 by calculate the distance to it in a tactile manner.

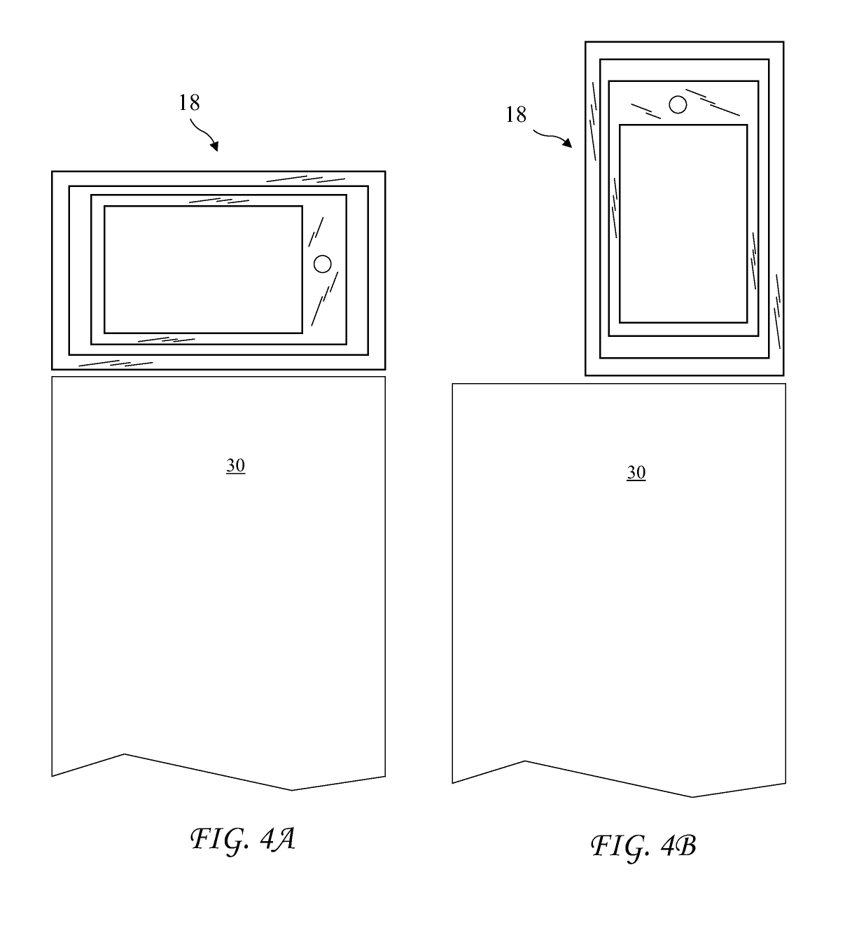

FIG. 4A and FIG. 4B the tactile apparatus 8 mounted in two different positions at the end of an armrest 20.

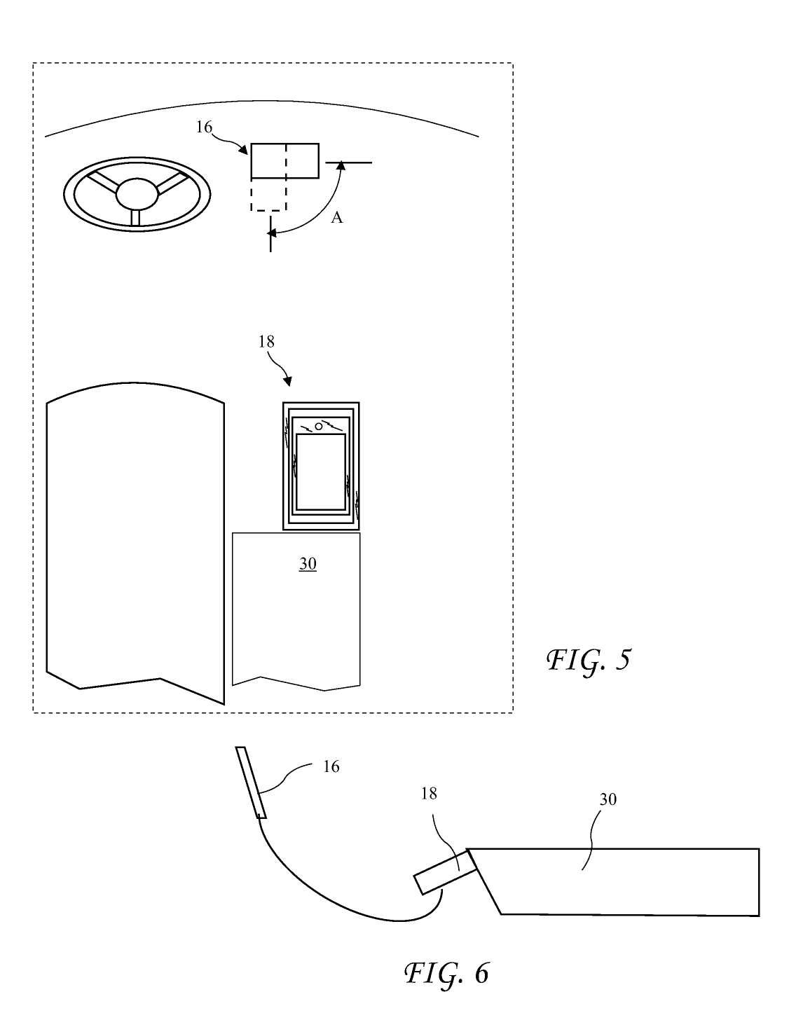

FIG. 5 shows how the two different positions of the control touchscreen apparatus 8 correspond with two different positions of the monitor 22. The angle A is usually of 90 degrees.

FIG. 6 shows how, in case of the control touchscreen is smart phone, apparatus 8 is connected via a HDMI connection, and an optional audio connection, 24 to the monitor 22.

The present invention preferably provides activation/lighting of the display 16 only when the vehicle brake pedal is touched by the foot and the control touchscreen at the armrest is touch by the fingertips simultaneously. This allows operating the vehicle's computer relatively safely while a vehicle comes to a stop and stays on a stop. In such, the vehicle driver takes advantage, especially in a heavily congested traffic, of the down time while driving. Any activation/lightening of the computer screen while the brake pedal and the control touchpad are not activated simultaneously is not recommended, but is safer then operating a handheld or fix computer device, smart phones, tablets or laptops.

Apart from inside the vehicle use, the specifically angled touchscreen or touchpad apparatus can be attached to any human arm like a wrist watch, with or without a mirror monitor display in top of the wrist, and with a touchscreen or touchpad under the fingertips, in order to allow two dimensional remote control any computer via wires or wireless. The control monitor in top of the wrist can be angled for optimal use and when not in use can be folded down in top of the arm in order not to hamper the normal human arm use. When not in use, the touchscreen or touchpad under the fingertips can be folded under the human arm enabling to carry the device at all times without hampering the arm's normal human use.

A benefit of the present invention is the use of the above described apparatus in order to handle a smart phone touchscreen, or any control touch screens or pads or such, placed on an armrest, without looking at said touchscreen(s) but by looking at a mirroring monitor placed in front of the person that does the controlling of the touchscreen placed on the armrest. The about one inch high walls around the touchscreen of the smartphone, or such, allows tensioning of the fingers in between so that the tactile position of the touchscreen, or such, can be establish without touching the touchscreen, because touching the touchscreen will have as result a computer command. The controller will want to first find in a tactile manner where certain areas of the touchscreen are before touching them, operation that will have as result a computer command.

After finding in a tactile manner where the touchscreen is, the operator will slide his/hers fingers between the walls described above until the fingers reach the margins of the touchscreen and then can secure the position of one, or more fingers, in the one third of an inch depression between the touchscreen and the walls assuring the position of the fingers in relation with the touchscreen in a tactile manner.

With the touchscreen, or such, positioned with the longer side against the end of the armrest, an example of such an operation is the fingers slide in until they reach the touchscreen. And then the thumb fingers secures itself the one third of an inch depression between the corner of the screen and corner of the walls while the pinkie fingers can find in a tactile manner the menu button on an iPhone and press it as needed. In another example with the thumb finger secured in the same position two other fingers can execute a pinch operation on the touchscreen. Or type on it knowing by feeling the distance between the thumb finger and the other fingers where about each key of the keyboard on the touchscreen is.

In different embodiments the control touchscreen of a smart phone, or such, can be positioned in relation with the and of armrest with the longer side against the armrest or with the shorter side against the armrest. The monitor positioned on the central console of the car, or other designated place, can be rotated 90 degrees so that the view corresponds with the position of the control touchscreen against the end of the armrest in the choice of the longer side against it or the shorter side against it.

In different embodiments the rotating in sequence of the control touchscreen and the monitor can be made at about 90 degrees on the axle at the intersection of the four corners of the touchscreen and monitor or on a different axle along the equal distance between the longer sides of the control touchscreen, respectively the monitor.

The tactile apparatus is best made out of polished wood covered with fine finishing substances. The tactile apparatus can be made out of many other materials such as plastics.

In case that the control touch screen or pad is a smart phone best is to be connected with the monitor via a HDMI cable using the mini HDMI port of the smart phone or the USB port with a HDMI convertor adapter. In different embodiments the port can be used also for re charging the smart phone while mounted in the tactile apparatus. In different embodiments the audio and microphone jack can be also connected with either the vehicle stereo system or with a monitor equipped also with audio output and input.

In another embodiment the remote control touchscreen can be placed in the forward part of e bicycle or motorcycle handle bar with the computer monitor or tablet placed on the handle bar. On a motorcycle or a motorized bicycle the monitor should light up only when the motorcycle or motorized bicycle, or other such motorized two wheels vehicle, like mopeds, are not in motion.

For three-dimensional control, the touchscreen or touchpad may be replaced by a connected with the computer glove controlled by the fingertips. The essential element of the method of the invention is the optimal angle between the touchscreen/touchpad and the human arm that allows touch control by fingertips without utilizing any human arm muscle that will engage other body muscle as well in the human body orientation process, allowing in this mod human body orientation independent of the fingers' movement. In order to control a computer, the apparatus essentially uses the optimal and typical hand versus human arm angle of control commonly used in handwriting. This apparatus will develop in time human habit of typing with one hand, therefore replacing in time the traditional handwriting with a computer assisted more precise method of writing, allowing for a universal computer control with the same device in the same time.

Control of a computer by using two hands and a mouse or a touchscreen generally requires the involvement of two hands and therefore the whole human body is essentially trapped in a more or less comfortable position during this operation. The whole human body has to be oriented towards operating the computer. The present invention frees human body and it's orientation in space from this constrains.

The habit of typing with one hand in a vehicle will eventually lead to the habit of typing with one hand. Human handwrites by using one hand only, and the specific position of the human arm versus hand during the process of handwriting allows for a disengagement of the rest of the human body from the process of writing. That allows for a greater concentration of the thought process to the subject of the writing rather then the process of writing. That is why many writers today still prefers to handwrite rather then type by using the two hands required on a standard typewriter keyboard or computer keyboard. The present invention allows humans to write at a computer with the same disengagement that handwriting allows, moreover, allows full control a computer via a touchpad with the same disengagement that handwriting allows.

The present invention includes a control device, for example a touchscreen, the size of which is within the reach of human fingers of one human arm, with prominent margining that will allow the fingers to detect where those margins are, and so allow the operator to keep the hand positioned on the touchpad optimally for the pre learned position of the keys without looking. The device allows typing without looking or only by looking at a keyboard displayed on the monitor positioned remotely within the field of view of the computer operator. Those who still need to look at the keyboard displayed on the remote monitor, in time will learn the hand to press the appropriate keys of touchpad and type with one hand only without looking, process similar with that of learning how to handwrite. The angle between arm/armrest/wristlock and the control device, for example, the hand, touchscreen, or touchpad, may be personalized by each user's comfort, will hold the touchpad within the same comfort of a pencil while handwriting. Such angle is preferably about 45 degrees.

As a consequence of the present invention all existing vehicle fleet can be retrofitted with an armrest that has a touchpad that can be connected via an electronic port to a smartphone or tablet or computer laptop, or a such device that is placed and mounted in the driver's field of view, making driving while operating smartphones, or such devices, much more safer. For the additional driving security, the vehicle fleet can be so retrofitted that the smartphone or tablet or such device's screen lights up only when the vehicle's brake pedal and the armrest control touchpad is engaged simultaneously.

The control armrest touchpad can control multiple devices. Example of multiple controls is a detachable smartphone and affixed to the vehicle native navigation system. The armrest can be fitted with multiple with multiple electronic ports, for example USB ports, and a selective bottoms in order to select the touchpad control and use at one time of each device.

The angle between the armrest and control device may vary as a function of the various driver seat position offered by different make and models of vehicle, so that the effortless fingertips operation of the touchpad, without engaging arm and human body muscles, can be achieved.

In an alternate embodiment the mirror control touchpad can be positioned on back side of the steering wheel, too, so that the right (or left) hand stays on the steering wheel and the fingertips can reach the touchpad under same ideal angle mentioned above. Also, in this embodiment the monitor can be place on the front side of the steering wheel. However, in this embodiment, during the controlling of the computer and the driving of the car simultaneously it will be more difficult for the human body to maintain the field of view and the good orientation of the vehicle then in the armrest position of the control touchpad.

In an alternate embodiment the armrest is elongated in order to support the human arm in such way that the fingertips reach directly to the touchscreen monitor.

In different alternate embodiments the control touchscreen/touchpad can be placed less efficiently in different positions the armrest area. In one of the embodiments the control touchscreen/touchpad is placed upward on the armrest within the reach of fingertips.

Apart from inside the vehicle use, the specifically angled touchscreen or touchpad apparatus can be attached to any human arm like a wrist watch, with or without a mirror monitor display in top of the wrist, and with a touchscreen or touchpad under the fingertips, in order to allow two dimensional remote control any computer, TV or other electronics via wires or wireless. The control monitor in top of the wrist can be angled for optimal use and when not in use can be folded down in top of the arm in order not to hamper the normal human arm use. When not in use, the touchscreen or touchpad under the fingertips can be folded under the human arm enabling to carry the device at all times without hampering the arm's normal human use. This universal remote control of a computer device can be coupled with a control monitor mounted on a helmet or mounted on many other convenient for human monitoring places.

In another embodiment the present invention may be used by any other passenger that desire to use his touch smart phone, placed as described above on an armrest, while the passage is looking at a comfortable large display monitor mirroring the touch phone, or such, monitor mounted in the vehicle in front of the said passenger. A similar set up can be use in many other situations. An example of such situation is a flying airplane.

While the invention herein disclosed has been described by means of specific embodiments and applications thereof, numerous modifications and variations could be made thereto by those skilled in the art without departing from the scope of the invention set forth in the claims.

I claim:

1. A vehicle mounted control device and display comprising:
an armrest;
a generally horizontal armrest surface on a top surface of the armrest for resting a driver's arm while driving; and
a touchpad mounted at a forward end of the armrest and extending forward from the armrest surface.

2. The vehicle mounted control device and display of claim 1, wherein the touchpad extends forward and downward from the armrest surface.

3. The vehicle mounted control device and display of claim 2, wherein the touchpad extends forward and downward from the armrest surface at about 45 degrees.

4. The vehicle mounted control device and display of claim 3, further including a monitor placed forward of the touchpad, in the view of the driver, the monitor electrically connected to the touchpad to display touchpad images.

5. The vehicle mounted control device and display of claim 4, wherein the armrest is mounted to a driver's door.

6. The vehicle mounted control device and display of claim 1, wherein the touchpad extends forward and upward from the armrest surface

7. The vehicle mounted control device and display of claim 5, further including a monitor placed forward of the touchpad, in the view of the driver, the monitor electrically connected to the touchpad to display touchpad images.

8. The vehicle mounted control device and display of claim 5, further including a monitor placed forward of the touchpad, in the view of the passenger, the monitor electrically connected to the touchpad to display touchpad images

9. The vehicle mounted control device and display of claim 7, wherein the armrest mounted touchpad is mounted to a driver's door.

10. The vehicle mounted control device and display of claim 8, wherein the armrest mounted touchpad is mounted to a passenger's door.

11. The vehicle mounted control device and display of claim 8, wherein the armrest mounted touchpad is mounted to a passengers' central armrest.

12. An tactile control apparatus comprising:
an open top housing having a depression about one inch deep, the housing residing at a forward end of an armrest; and
a control device residing in the housing.

13. The tactile control apparatus of claim 12, wherein the housing provides a gap of about one third of an inch depression around the control device.

14. The tactile control apparatus of claim 12, wherein the tactile control apparatus is mounted on the extension of an armrest.

15. The tactile control apparatus of claim 12, wherein the armrest is a center consul arm rest.

16. A vehicle armrest mounted touchpad comprising:
a drivers door armrest;
a generally horizontal top armrest surface of the arm rest; and
a touchpad mounted at a forward end of the armrest and extending forward from the armrest surface.

17. The vehicle armrest mounted touchpad of claim 16, wherein the touchpad extends forward and downward from the armrest surface.

18. The vehicle armrest mounted touchpad of claim 17, wherein the touchpad extends forward and downward from the armrest surface at about a 45 degree angle.
